(19) United States
(12) Patent Application Publication
(10) Pub. No.: US 2002/0012718 A1
(43) Pub. Date: Jan. 31, 2002

(54) GLUTEN-FREE BEER

(76) Inventors: GIOVANNI MACCAGNAN, VIGNOLA (IT); ANTONIO PAT, FELTRE (IT); FRANCESCO COLLAVO, ALANO DI PIAVE (IT); GIAN LUCA RAGG, MILANO (IT); MARINA PIERANNA BELLINI, MILANO (IT)

Correspondence Address: JACOBSON PRICE HOLMAN & STERN, THE JENIFER BUILDING, 400 SEVENTH STREET N W, WASHINGTON, DC, 20004

(21) Appl. No.: 09/271,376

(22) Filed: Mar. 18, 1999

(30) Foreign Application Priority Data
Apr. 8, 1998 (EP) 98830214.7

(51) Int. Cl. C12C 3/08

(52) U.S. Cl. 426/13

(57) ABSTRACT

A gluten-free beer obtained from a mixture of starting materials comprising at least one gluten-free cereal and enzymes for saccharifying the starch contained in this cereal, which is preferably chosen from the group comprising buck wheat, sorghum and millet and is advantageously buck wheat; such a beer is obtained by a method comprising a stage of saccharifying a mixture comprising at least one gluten-free cereal and saccharification enzymes, in particular amylolytic enzymes and glucanase, and is particularly suitable for consumption by gluten-intolerant individuals.

### FIELD OF THE INVENTION

The present invention relates to a new type of beer which can be tolerated by celiac disease sufferers.

### BACKGROUND ART

Celiac disease is characterized by persistent intolerance to gluten, which induces atrophy of the jejunal villi, with hyperplasia of the crypts and poor absorption of many nutrient substances, with the consequent clinical signs and symptoms, such as weight loss, diarrhea, abdominal swelling, anaemia caused by iron or vitamin deficiency, osteoporosis and the like. Epidemiological studies carried out in Europe have reported a prevalence of celiac disease in adults of 1:950 in Sweden and 1:1700 in Scotland. These data are based on symptomatic and diagnosed cases, but it is commonly believed that the actual prevalence of celiac disease is considerably higher and that, in the general population, it is close to 1:300.

Celiac disease sufferers must thus avoid consuming gluten-containing aliments such as, for example, beer; beer is an aliment produced by alcoholic fermentation of sugary wort prepared by the diastasic saccharification of barley starch, to which other types of cereals are optionally added. However, barley contains a large amount of gluten and thus makes beer an aliment which must be excluded at all costs from the diet of celiac disease sufferers.

### SUMMARY OF THE INVENTION

The problem underlying the present invention is thus to provide a new beer which can be consumed by this sizeable proportion of the population.

The problem is solved, according to the invention by a gluten-free beer obtained from a mixture of starting materials comprising at least one gluten-free cereal, and enzymes for saccharifying the starch contained in the at least one said cereal.

In one particular embodiment of the present invention, the at least one said cereal is chosen from the group comprising buck wheat, sorghum and millet. The said cereal is advantageously buck wheat.

Buck wheat has suitable beermaking properties, as regards both appearance and taste, and can thus be used as a replacement for barley.

However, buck wheat does not contain the enzymes required to hydrolyse starch to maltose, and so these enzymes, preferably a-amylase and glucanase, must be added separately.

In a preferred embodiment of the present invention the mixture consists of 40-80% by weight of buck wheat and from 20 to 60% by weight of a syrup obtained by the hydrolysis of gluten-free starch such as, for example, corn starch, rice starch, potato starch, etc. The syrup used is preferably a syrup obtained by the hydrolysis of corn starch, which will be referred to hereinbelow simply as corn syrup.

The use of a gluten-free cereal syrup instead of the cereal itself has the advantage of making it no longer necessary for the cereal to undergo the saccharification step, thereby simplifying the entire production process considerably.

In a particularly preferred embodiment, the mixture is composed of buck wheat in a variable amount of from 40 to 60% by weight, and corn syrup in a variable amount of from 40 to 60% by weight. Excellent results are obtained when the mixture is composed of buck wheat and corn syrup in a weight ratio of 50:50.

Should the mixture of starting materials not have a sufficient amount of water-soluble proteins to give the beer obtained therefrom the required organoleptic properties, such as, for example, the presence and consistency of the head, a protease which is capable of making some of the protein content of the cereals water-soluble may be added to the starting mixture.

The beer according to the invention advantageously contains a coloring agent, preferably caramel.

The present invention also relates to a method for producing the gluten-free beer described above, this method comprising a stage of saccharifying a mixture comprising at least one gluten-free cereal and saccharification enzymes.

The beer according to the present invention has the great advantage of being entirely free of gluten and thus can be consumed by celiac disease sufferers without giving rise to the abovementioned undesired effects, and at the same time having organoleptic properties and an appearance which are entirely comparable with those of beer from barley malt. Not only the odour and the taste, but also the amount and consistency of the head which forms when the beer is poured into a glass, are entirely similar to those of conventional beer.

### DETAILED DESCRIPTION OF THE INVENTION

The invention will now be described in its preferred embodiments, by way of non-limiting examples, in order to allow it to be understood more clearly.

### EXAMPLE 1

2650 kg of buck wheat, 3.5 kg of calcium chloride, 4 kg of calcium sulphate, 13 kg of caramel (EU category E150C) and 9 m³ of water are mashed in a copper for a period of 30 min and at a temperature of 50° C. 4.5 kg of a-amylase is added to the mixture thus obtained, which is then raised to 78° C. over a period of 15 min, left at this temperature for a period of 15 min and then brought to the boiling point and left at that temperature for 30 min. Next, the mash is cooled to 64° C. by addition of 6.5 m³ of water. 5 liters of orthophosphoric acid are also added, giving the mash a pH of 5.6±0.1. The contents of the copper are transferred into a mash tun, into which 4.5 kg of a mixture of glucanase and a-amylase (1:1) and 4.5 kg of protease are added. At this point the saccharification stage starts, during which the starches contained in the buck wheat are converted into fermentable sugars by the action of the added enzymes, and the mixture remains at a temperature of 64° C. for 30 min.

The temperature is then raised to 720° C. over a period of 15 minutes and is maintained at this value for 25 min; the temperature is then raised to 76° C. (ideal temperature for the filtration) and is maintained at this value for 10 min. At this point, the liquid (first wort) is separated out and about 10 m³ of water are then added in order to extract all of the sugar from the spent grains. The filtrate thus obtained is transferred into a cooking copper and 3 m³ of water and 2650 kg of corn syrup are added (50:50 buck wheat/corn syrup weight ratio).

The mixture thus obtained is boiled until 7-8% of the total mass has evaporated off.

As soon as the mixture begins to boil, 4 kg of HNB hop extract with 30% of alpha acids and 6 liters of ortho-phosphoric acid are added in order to give the solution a pH of 5.2±0.1. After boiling for 40 minutes, a further 10 kg of Pel.T90 hops are added. The product thus obtained is then transferred into a whirl pool in order to separate the coagulated proteins and the hop grain from the liquid phase.

A wort is thus obtained which is ready for fermentation. To this end, it is cooled to a temperature of 13° C., aerated with 10 ppm of oxygen and Saccharomyces carlsbergensis yeast is added, which is purified beforehand of any possible trace of gluten by repeated washing with water, and in solution at a concentration of 50% (one liter per one hundred liters of wort, so as to obtain a density of 16 million cells/ml).

The initial fermentation temperature is 13° C., but rises to 14° C. within the first 12 hours. The liquid then remains at this temperature until a value of 5° P. is reached, after which the temperature is allowed to increase to a maximum of 16° C., and remains at this value until the fermentation is complete and a total diacetyl concentration of <0.15 ppm is reached (168-192 hours).

The beer is then separated from the yeast, transferred and matured by conventional techniques.

The gluten-free beer thus obtained has the

| | | | |
|---|---|---|---|
| Original gravity (% w) | 11.30 | pH | 3.8 |
| Original gravity (% v) | 11.79 | Head retention (sec) | 250 |
| Real extract (% v) | 3.75 | Colour (EBC) | 6.0 |
| Apparent extract (% v) | 1.90 | Bitterness (EBU) | 20 |
| Alcohol (% v) | 5.0 | Total nitrogen (mg/l) | 180 |
| Limit attenuation (%) | 87.0 | CO₂ (g/l) | 5.5 |

### EXAMPLE 2

The process described in Example 1 is repeated with the same experimental methods and procedures, changing only the amounts of the starting materials, i.e. using 3180 kg of buck wheat and 2120 kg of corn syrup.

The gluten-free beer thus obtained has the

| | | | |
|---|---|---|---|
| Original gravity (% w) | 11.30 | pH | 3.9 |
| Original gravity (% v) | 11.79 | Head retention (sec) | 280 |
| Real extract (% v) | 3.75 | Colour (EBC) | 6.0 |
| Apparent extract (% v) | 1.90 | Bitterness (EBU) | 20 |
| Alcohol (% v) | 5.0 | Total nitrogen (mg/l) | 210 |
| Limit attenuation (%) | 87.0 | Co₂ (g/l) | 5.5 |

### EXAMPLE 3

The process described in Example 1 is repeated with the same experimental methods and procedures, changing only the amounts of the starting materials, i.e. using 2120 kg of buck wheat and 3180 kg of corn syrup.

The gluten-free beer thus obtained has the following characteristics:

| | | | |
|---|---|---|---|
| Original gravity (% w) | 11.30 | pH | 3.7 |
| Original gravity (% v) | 11.79 | Head retention (sec) | 220 |
| Real extract (% v) | 3.75 | Colour (EBC) | 6.0 |
| Apparent extract (% v) | 1.90 | Bitterness (EBU) | 20 |
| Alcohol (% v) | 5.0 | Total nitrogen (mg/l) | 150 |
| Limit attenuation (%) | 87.0 | CO₂ (g/l) | 5.5 |

What is claimed is:

1. A gluten-free beer obtained from a mixture of starting materials comprising at least one gluten-free cereal and enzymes for saccharifying the starch contained in the said at least one cereal.

2. A beer according to claim 1, in which the said at least one cereal is chosen from the group comprising buck wheat, sorghum and millet.

3. A beer according to claim 2, in which the said mixture consists of buck wheat and enzymes for saccharifying the starch contained in the buck wheat.

4. A beer according to claim 2, in which the mixture consists of buck wheat in a variable amount of from 40 to 80% by weight, and a syrup, obtained by the hydrolysis of gluten-free starch, in a variable amount of from 20 to 60% by weight.

5. A beer according to claim 4, in which the said syrup is obtained by the hydrolysis of corn starch.

6. A beer according to claim 5, in which the said mixture is composed of buck wheat in a variable amount of from 40 to 60% by weight, and corn syrup in a variable amount of from 40 to 60% by weight.

7. A beer according to claim 5, in which the said mixture is composed of buck wheat and corn syrup in a weight ratio of 50:50.

8. A beer according to claim 1, in which the said enzymes are a-amylase and glucanase.

9. A beer according to claim 2, in which the said enzymes are a-amylase and glucanase.

10. A beer according to claim 3, in which the said enzymes are a-amylase and glucanase.

11. A beer according to claim 4, in which the said enzymes are a-amylase and glucanase.

12. A beer according to claim 5, in which the said enzymes are a-amylase and glucanase.

13. A beer according to claim 6, in which the said enzymes are a-amylase and glucanase.

14. A beer according to claim 7, in which the said enzymes are a-amylase and glucanase.

15. A beer according to claim 1, in which the said mixture comprises a protease.

16. A beer according to claim 8, in which the said mixture comprises a protease.

17. A beer according to claim 1, comprising a coloring agent.

18. A beer according to claim 8, comprising a coloring agent.

19. A beer according to claim 15, comprising a coloring agent.

20. A beer according to claim 17, in which the said coloring agent is caramel.

21. A beer according to claim 18, in which the said coloring agent is caramel.

22. A beer according to claim 19, in which the said coloring agent is caramel.

23. A method for producing a gluten-free beer, this method comprising a stage of saccharifying a mixture comprising at least one gluten-free cereal and saccharification enzymes.

24. A method according to claim 23, in which the said mixture comprises buck wheat and corn syrup.

25. A method according to claim 23, in which the saccharification is carried out in the presence of amylolytic enzymes and glucanase.

26. A method according to claim 24, in which the saccharification is carried out in the presence of amylolytic enzymes and glucanase.

27. A method according to claim 23, in which protease enzymes are added to the said mixture.

28. A method according to claim 24, in which protease enzymes are added to the said mixture.

29. A method according to claim 25, in which protease enzymes are added to the said mixture.

30. A method according to claim 26, in which protease enzymes are added to the said mixture.
